(19) United States
(12) Patent Application Publication
(10) Pub. No.: US 2003/0037028 A1
(43) Pub. Date: Feb. 20, 2003

(54) Automatic access to a local vendor from a mobile station

(76) Inventors: A. Akhteruzzaman, Naperville, IL (US); Paul Raymond Sand, Woodridge, IL (US); Richard Grant Sparber, Wheaton, IL (US); Claudis L. Young, Aurora, IL (US)

Correspondence Address: Docket Administrator (Room 3J-219), Lucent Technologies Inc., 101 Crawfords Corner Road, Holmdel, NJ, 07733-3030, US

(21) Appl. No.: 09/929,480

(22) Filed: Aug. 14, 2001

(51) Int. Cl. G06F 7/00

(52) U.S. Cl. 707/1

(57) ABSTRACT

Advertising is delivered to a mobile station and displayed on the mobile station's display when the mobile station is in the same sector as the advertiser. The subscriber merely has to press the “send” button to complete a call to the advertiser. The advertising may change periodically, or may request specific local advertisements.

### FIELD OF THE INVENTION

This invention relates, to the field of wireless telecommunications, and, more specifically, to a feature that provides advertisements to a wireless station of vendors in its vicinity and automatic connection of the wireless station to the local vendor.

### BACKGROUND OF THE INVENTION

Wireless technology and services have grown exponentially over the past several years. As more and more people subscribe to wireless service, wireless service providers compete for these new subscribers and attempt to differentiate their service with unique features. Simultaneously, service providers must keep costs down in order to maintain competitive prices.

One issue that is becoming more noticeable now that wireless telecommunications is so popular is that there are only a limited number of telephone numbers that a person can use with a mobile station. This is not an inherent limitation of the mobile station per se, because a mobile station can make a call to a telephone literally anywhere in the world. This limitation arises because a person can only remember a few telephone numbers. Mobile stations help to some extent; most have a memory for 30 to 100 or so telephone numbers. This memory is useless, however, for finding local goods and service providers, especially where the user is out of his/her home area. Directory assistance can only help if a name and address is known. Whereas a wireline user can consult a telephone book, the mobile subscriber has no equivalent, unless the mobile scriber carries around a library of telephone books.

Therefore, there is a problem in the art in that a mobile subscriber cannot access telephone numbers of providers of goods and services in the area where the mobile station is located.

### SUMMARY OF THE INVENTION

This problem is solved and a technical advance is achieved in the art by a feature for wireless service providers to direct local advertisement to a mobile station in the mobile station's current vicinity. Furthermore, the user of the mobile station can connect to the purveyor of these goods or services by simply pressing the “send” button while such advertising is being displayed. This invention uses short message service to transfer advertising, including display data and audio information (if available). An advertising server provides a base station with sector specific advertising for those mobile stations registered in the sector. There may be a plurality of rotating advertisements and/or advertisements that are a function time, date, range of times, etc. (e.g., restaurant advertisements during meal times).

In a further embodiment, the user can request advertisement through the mobile station, wherein the advertising server responds with one or more listings. The user may then scroll through the listings and select one or request further listings.

In this manner, a service provider can generate advertising revenue and provide a subscriber with local directory numbers automatically.

### BRIEF DESCRIPTION OF THE DRAWINGS

A more complete understanding of this invention may be obtained from a consideration of the specification taken in conjunction with the drawings, in which:

FIG. 1 is a block diagram of a wireless network that provides a feature according to an exemplary embodiment of this invention;

FIG. 2 is a flow chart of operation of an invention according to this exemplary embodiment operating in the wireless network of FIG. 1;

FIG. 3 is a call flow diagram of an exemplary embodiment of this invention; and,

FIG. 4 is a call flow of a further exemplary embodiment according to this invention.

### DETAILED DESCRIPTION

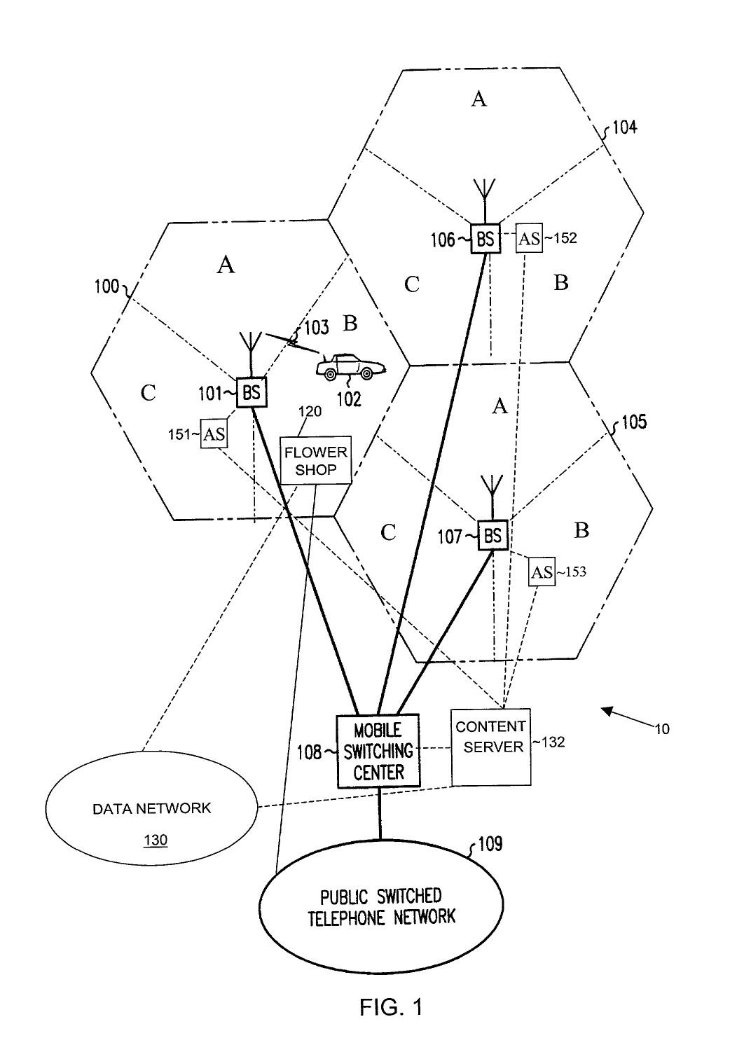

FIG. 1 illustrates a wireless communications network 10, that supports mobile station 102 during a wireless call. Mobile station 102, in this exemplary embodiment, is located within cell 100 and served by base station 101. Base station 101 communicates with mobile station 102 over radio channel 103. Other cells 104 and 105 in the wireless communications network 10 are served by base stations 106 and 107 respectively. Base stations 101, 106 and 107 are connected to and controlled by mobile switching center (MSC) 108. In addition, MSC provides a telephony connection between mobile stations such as 102 and the public switch telephone network (PSTN) 109.

Cells 100, 104 and 105 are divided into sectors A, B and C, as is commonly practiced in the art. In this manner, service providers deliver a better quality of service than with omni-directional antennas. However, this invention is not necessarily limited to sector-based wireless communication systems and may be used in omni-directional systems.

According to an exemplary embodiment of this invention, flower shop 120 is connected to the PSTN 109 in the usual manner according to the known art. Also, according to another exemplary embodiment of this invention, flower shop 120 is connected to a data network 130. This data network may be a public data network, such as the Internet, or may be a private data network operated by the service provider for the specific purpose of advertising over wireless network 10.

A content server 132 is connected to data network 130. Content server 132 receives advertisements via data network 130. Alternatively, content server 132 may receive advertisements through a dial up connection, as is known in the art. Content server 132 then determines the location of the advertiser relative to base stations 101, 106 and 107. This location determination may be made by a street address to geo-coordinates translator at the content server 132, or as part of the information delivered with the advertisement. Content server 132 then determines the base station and sector in which the advertiser is located.

Content server 132 organizes content by sector and distributes content to advertising servers 151, 152 and 153 in cells 100, 104 and 105 respectively. This distribution may be over a data network (such as a local area network) or, alternatively, communicated through MSC 108. Advertising servers 151, 152 and 153 provide advertising content to their respective base stations 101, 106 and 107 for broadcast over radio channels such as 103 to mobile stations such as 102. Content server 132 and advertising servers 151-153 may be separate platforms as illustrated, or may be integrated on one platform.

According to one exemplary embodiment of this invention, flower shop 120 contracts with the service provider to provide advertising through wireless network 10. Flower shop 120 provides information which may include name, address, other information (e.g., flowers and costs, music, voice, etc.) and a telephone number through data network 130 to content server 132. Content server 132 determines the geo-coordinates of flower shop 120 and compares these to a map of cell and sector geo-coordinates. In this example, flower shop 120 is located in cell 100, sector B, served by base station 101. Content server 132 sends the advertising information from flower shop 120 to advertising server 151 connected to base station 101.

Mobile station (MS) 102 registers with base station 101 in sector B when it is turned on or, alternatively, registers when it moves into this sector via hand-off, as is known in the art. Base station 101 requests advertising information from advertising server 151. Base station 101 then broadcasts this advertising information via short message service, for example, over radio channel 103 to MS 102 if MS 102 is idle. There may be a plurality of messages sent depending on the complexity of the advertisement and the capability of MS 102. For example, there may be pictures of products, audio, video or simply a name and telephone number. The advertisement is then displayed on the display of mobile station 102, and the telephone number placed in a register for dialing.

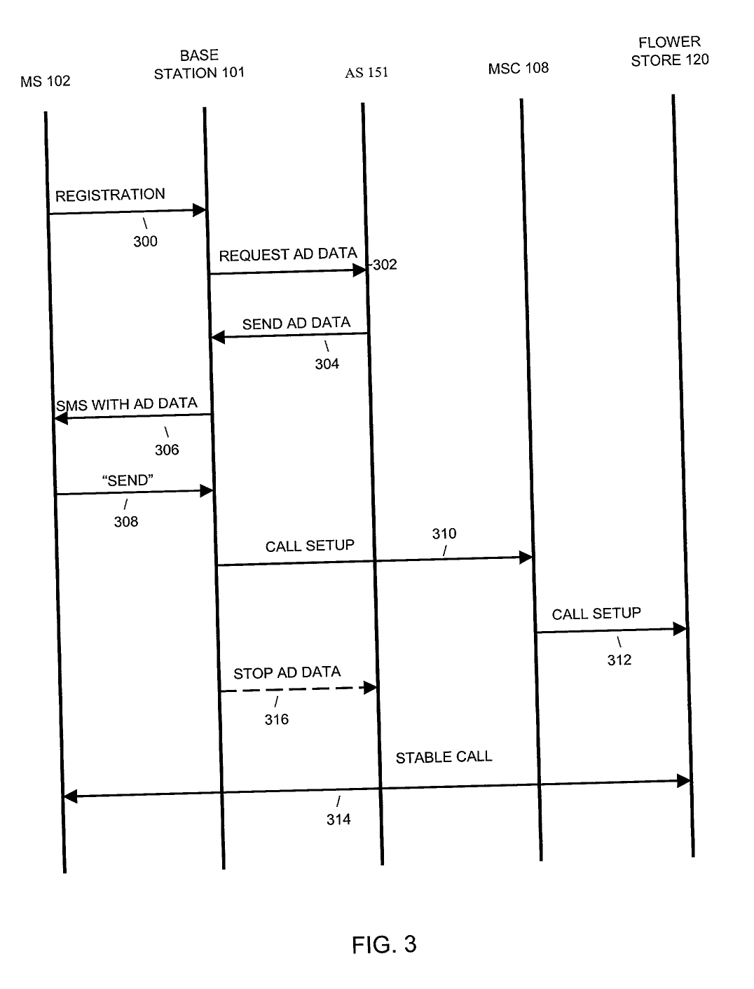

If the user of MS 102 decides to contact flower shop 120 responsive to the advertisement, the user merely pushes the “send” button on MS 102. The telephone number supplied by flower shop 120 is delivered by radio channel 103 to base station 101 as in standard call set up (discussed below in connection with FIG. 3). Base station 101 connects through MSC 108 and through PSTN 109 to flower shop 120.

Multiple advertisers may advertise in the same sector for either the same or different products or services. Base station 101 may periodically request advertising from advertising server 151 (or alternatively, advertising server 151 may deliver advertising information periodically to base station 101). Base station 101 then updates MS 102 with a new advertisement.

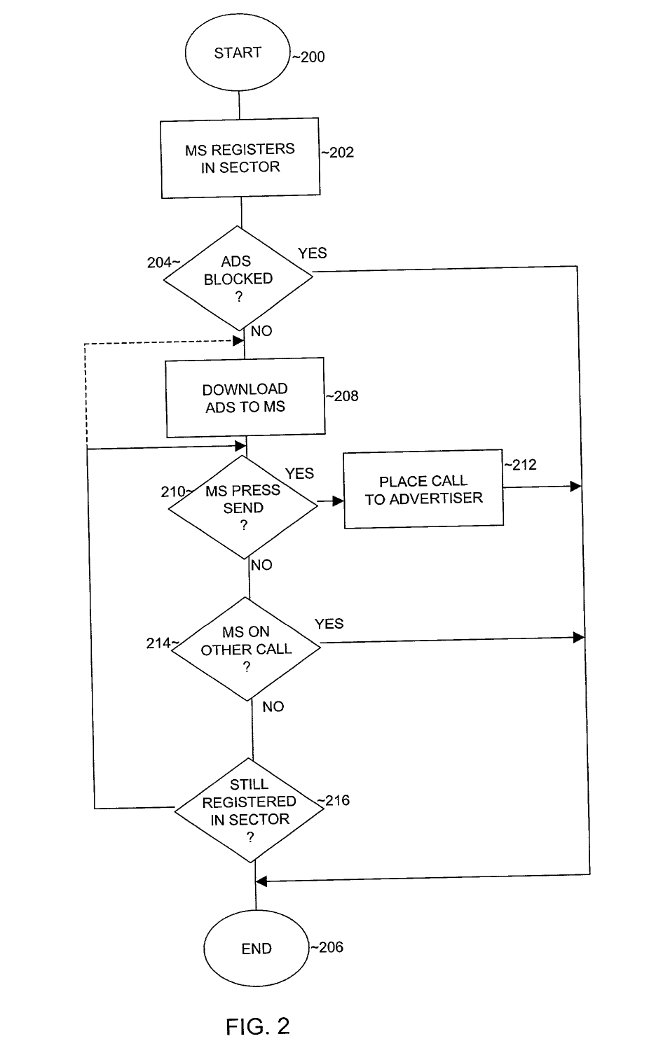

Turning now to FIG. 2, a flow chart is shown illustrating call flow operations of base station 101 according to an exemplary embodiment of this invention. Processing starts at circle 200 and moves to action box 202 where MS 102 registers within a cell and sector. In the exemplary embodiment of FIG. 1, MS 102 registers in cell 100, sector B. Such registration may take place either when MS 102 powers on, when MS 102 moves into cell 100 and periodically updates its registration as is known in the art, or when MS 102 is handed off from another cell and/or sector.

Processing continues to decision diamond 204 where a determination is made if this mobile station has advertising blocked. A further feature of this invention may be that the user can select to block advertising either as an extra cost feature or on a convenience basis, depending on the service provider. If the MS 102 has advertising blocked, then processing ends in circle 206.

If, in decision diamond 204, advertising is not blocked, then processing continues to action box 208, where an advertisement is down-loaded to MS 102 from the base station 102 using, for example, short message service. Processing continues to decision diamond 210 where determination is made if the user of the mobile station presses the “send” button. If the user did press the “send” button, then processing continues to action box 212, where a call is placed to the advertiser in the normal manner and processing exits through circle 206.

If, in decision diamond 210 the user of the mobile station 102 does not press the “send” button, then a determination is made if the mobile station is on another call. If the mobile station is on another call, it is probable that the user does not want to be disturbed by and will not be looking at advertising, so no further advertising is sent and processing ends in circle 206.

If, in decision diamond 214, the mobile station is not on another call, then processing proceeds to decision diamond 216, where the determination is made if the mobile station is still in the sector. If the mobile has been handed off to another sector, or, alternatively, has been powered down, then processing ends in circle 206. If the mobile station is still active in the sector, then processing loops back to decision diamond 210. Alternatively, if more than one advertisement is being displayed, processing may follow the dotted line to proceed back to action box 208 where another advertisement is downloaded to mobile station 102.

Turning now to FIG. 3, a call flow for the exemplary embodiment described in FIG. 1 and FIG. 2 are shown. MS 102 sends a registration message 300 to base station 101. In response base station 101 sends a request advertisement data message 302 to advertising server 151. Advertising server 151 responds with advertising data 304 to base station 101, which forwards the advertising data via short message service 306 to MS 102.

At some later time, MS 102 presses the “send” button, which sends a call setup message 308 to base station 101. Base station 101 forwards the call setup in message 310 to MSC 108, including the telephone number of the advertiser (flower shop 120). MSC 108 sends a call setup message 312 through the PSTN, as is known in the art, to flower shop 120. A stable call 314 is then established between mobile subscriber 102 and flower shop 120. Further, a stop advertising data message can be sent from base station 101 to advertising server 115 when mobile subscriber 102 is on a call to avoid messages flooding base station 101.

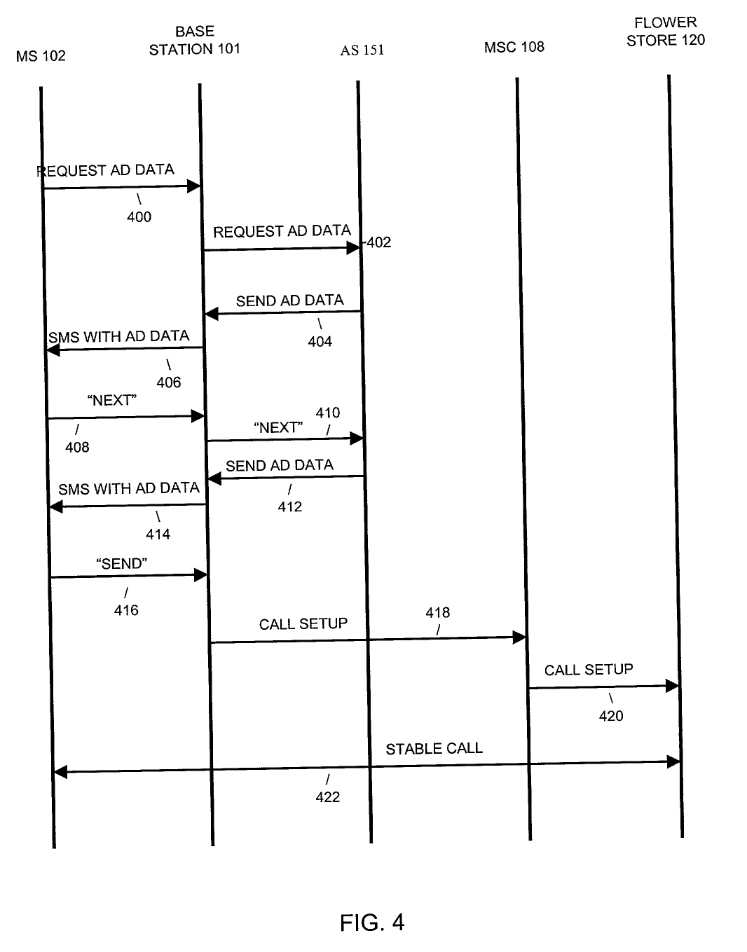

In another exemplary embodiment, advertising information may be provided on an MS 102 request basis, as illustrated in the call flow of FIG. 4. A request for advertising information 400 is sent from 102 to base station 101. Base station 101 forwards the requested data message 402 to the advertising server 115, which responds with advertising data 404. Base station 101 then forwards the advertising data to MS 102 via, for example, short message service 406. MS 102 may then either press the “send” button if the advertiser is one to be contacted, or alternatively, presses a “next” button which forwards a “next” message 408 to base station 101. The “next” message is forwarded 410 from base station 101 to advertising server 151. Advertising server 151 responds with the next advertising data 412, which may be organized alphabetically, by type or group of service or product or both. The advertising data is then forwarded from base station 101 to MS 102 via short message service 414. Eventually MS 102 presses the “send” button 416 which causes base station 101 to establish a call 418 through MSC 108 to flower shop 120, which eventually results in a stable call 420 between MS 102 and flower shop 120.

It is to be understood from the above-described embodiments are merely illustrative principles of the invention and that many variation may be devised by those skilled in the art without departing from the scope of this invention. For example, a “white pages” directory may be established according to the principles of this invention. Listed subscribers and other registered mobiles may be maintained in a directory in an advertising server. A signal may be sent from MS 102 to deliver selected names and telephone numbers (i.e. all last names beginning with the letter “J”). The user may scroll through the list and connect to an entry in the list by pressing the “send” key. It is, therefore, intended that such variations be included within the scope of the following claims.

What is claimed is:

1. A method for use in a wireless communications network that provides automatic access to a local vendor from a mobile station, said method comprising the steps of:
selecting an advertisement for said mobile station depending upon said mobile station's location in said wireless network;
delivering said advertisement to said mobile station;
sending a “send” message from said mobile station to said base station; and
connecting said mobile station to said advertiser.

2. A method in accordance with claim 1 wherein said wireless communications network comprises a plurality of cells, wherein said step of selecting is dependent upon the cell where the mobile station is located.

3. A method in accordance with claim 1 wherein said wireless communications network comprises a plurality of cells, each of said cells being divided into a plurality of sectors, wherein said step of selecting is dependent upon the cell and sector where the mobile station is located.

4. A method in accordance with claim 1 wherein said wireless communications network comprises a plurality of cells, each of said cells being divided into a plurality of sectors, further including the step of:
determining the location of said mobile station by the cell and sector in which it is registered.

5. A method in accordance with claim 1 wherein said wireless communications network comprises a plurality of cells, each of said cells being divided into sectors, the wireless network includes one or more advertising servers, wherein said step of selecting an advertisement comprises:
determining which one of said one or more advertising servers contains advertising local to the cell and sector in which the mobile station is located.

6. A method in accordance with claim 1 wherein, if said mobile station does not send the “send” message in a predetermined time, sending another advertisement to said mobile station.

7. A method in accordance with claim 1 wherein said step of determining includes:
receiving a request for information from said mobile station; and
selecting one or more advertisements responsive to said request.

8. A method in accordance with claim 7 wherein said one or more advertisements comprises telephone listings of individuals.

9. A method in accordance with claim 1 wherein said mobile communications systems includes a content server and a plurality of advertising servers, wherein said method further includes the step of:
receiving a plurality of advertisements from advertisers at predetermined locations at said content server;
determining the advertising server that serves the location of said advertiser; and
periodically sending said one of said plurality of advertisements to said advertising servers according to location.

10. A method in accordance with claim 1 wherein said step of delivering said advertisement comprises sending said advertisement via a short message service message.

11. A method in accordance with claim 10 wherein said step of delivering said advertisement comprises sending said advertisement via a plurality of short message service messages.
